(19) United States
(12) Patent Application Publication
(10) Pub. No.: US 2024/0216890 A1
(43) Pub. Date: Jul. 4, 2024

(54) THE ORGANIC COMPOUND ADSORBENT AND GAS BLOWER COMPRISING THE SAME

(71) Applicant: LG CHEM, LTD., Seoul (KR)

(72) Inventors: Kyo Sung PARK, Daejeon (KR); Min Ki CHOI, Daejeon (KR); Tae Hee LEE, Daejeon (KR); Se Hyun KWON, Daejeon (KR); Do Young PARK, Daejeon (KR); Chang Hoon SHIN, Daejeon (KR)

(21) Appl. No.: 18/292,319

(22) PCT Filed: Aug. 9, 2022
(86) PCT No.: PCT/KR2022/011852

§ 371 Date: Jan. 25, 2024

(30) Foreign Application Priority Data
Aug. 30, 2021 (KR) 10-2021-0114705
Jul. 25, 2022 (KR) 10-2022-0091911

(51) Int. Cl. B01J 20/22; B01D 53/02; B01J 20/20; B01J 20/28

(52) U.S. Cl. CPC B01J 20/226; B01D 53/02; B01J 20/205; B01J 20/28061; B01J 20/28064; B01J 20/2808; B01J 20/28083; B01D 2253/204; B01D 2253/306; B01D 2253/308; B01D 2257/708

(57) ABSTRACT

An organic compound adsorbent and a gas blowing apparatus comprising same, wherein the organic compound adsorbent has a BET specific surface area of 500 m²/g or more, and the relationship between an average diameter of unit pore inlets and an average diameter inside unit pores of the metal organic framework satisfies Equation 1:

$$0.4 \leq x ( nm ) / y ( nm ) \leq 1. \qquad [ Equation 1 ]$$

wherein: x is an average diameter of a unit pore inlet of the metal organic framework; and y is an average diameter inside a unit pore of the metal organic framework, and thus even in a dynamic gas flow having a flow rate of 1 cm/sec or more, the adsorption amount and the adsorption rate of volatile organic compounds can be improved, and therefore volatile organic compounds can be efficiently adsorbed in environments having a gas flow, such as an air purifier and an air conditioner.

### CROSS-REFERENCE TO RELATED APPLICATIONS

This application is a National Stage Application of International Application No. PCT/KR2022/011852 filed on Aug. 9, 2022, which claims priority from Korean Patent Application Nos. 10-2021-0114705, filed on Aug. 30, 2021, and 10-2022-0091911, filed on Jul. 25, 2022, the disclosures of which are incorporated by reference herein.

### TECHNICAL FIELD

The present invention relates to an organic compound adsorbent and a gas blower including the same, and more specifically, to an organic compound adsorbent which can improve the adsorption amount and adsorption rate of a volatile organic compound under a condition of dynamic gas flow, and a gas blower including the organic compound adsorbent.

### BACKGROUND

Among gases, substances such as fine dust, ultrafine dust, harmful gases, germs, fungi, and viruses are floating, and these floats cause diseases and have a bad effect on health. In particular, volatile organic compounds are air pollutants and toxic compounds having carcinogenicity and have a very harmful effect on the human body.

In order to reduce such volatile organic compounds, an organic compound adsorbent including activated carbon has been used in an air purifier, an air purification filter, an air conditioner, and the like, but there has been a limitation in that while the organic compound adsorbent exhibits excellent effects in removing toluene from the volatile organic compounds, the performance of removing formaldehyde and ammonia is weak.

Recently, the metal organic framework (MOF), which is a porous organic metal structure, has been reported to be capable of improving the performance of removing formaldehyde and ammonia from volatile organic compounds, but there has been a limitation in that the performance of removing volatile organic compounds is deteriorated under a condition of dynamic gas flow, such as an air purifier or an air conditioner. Although the same MOF is used, each MOF is different in a size of the unit pore inlet, a size inside the unit pore, or a shape of the pore, and thus there has been a limitation in that there can occur a difference in the content of the volatile organic compounds adsorbed inside the pores, and the difference occurs more in a condition of dynamic gas flow than in a condition of static gas flow.

Therefore, there is a need for research on a structure of a metal organic framework capable of adsorbing a large amount of volatile organic compounds in a short time even under a condition of dynamic gas flow.

### BRIEF DESCRIPTION

### Technical Problem

To solve the above-described limitations, an aspect of the present invention is intended to provide an organic compound adsorbent capable of improving the adsorption amount and adsorption rate of volatile organic compounds adsorbed inside the pores under a condition of dynamic gas flow by optimizing a BET specific surface area of the metal organic framework, the average diameter range of the unit pore inlet of the metal organic framework, and the average diameter range inside the unit pores, based on the relationship between the structure of the metal organic framework and the adsorption ability of the volatile organic compounds, and a gas blower including the organic compound adsorbent.

### Technical Solution

According to an aspect of the present invention, provided are an organic compound adsorbent and a gas blower.

(1) According to an aspect of the present invention, provided is an organic compound adsorbent including: a metal organic framework which contains variable pores by a binding structure of metal ions and organic ligands, has a BET specific surface area of 500 m²/g or more, and satisfies Equation 1 below under gas flow having a flow rate of 1 cm/sec or more; and a carbonaceous support supported with the metal organic framework:

$$0.4 \leq x ( nm ) / y ( nm ) \leq 1. \qquad [ Equation 1 ]$$

wherein in Equation 1 above:
x is the average diameter (nm) of the unit pore inlets of the metal organic framework as measured by at least one method selected from among an X-ray diffraction, a gas adsorption, and a mercury porosimeter; and
y is the average diameter (nm) inside the unit pores of the metal organic framework as measured by at least one method selected from among an X-ray diffraction, a gas adsorption, and a mercury porosimeter.

(2) In (1) above of the present invention, provided is the organic compound adsorbent wherein x above can be 0.2 nm to 1.4 nm, and y above can be 0.5 nm to 2.2 nm.

(3) In (1) or (2) above of the present invention, provided is the organic compound adsorbent wherein x above can be 0.35 nm to 1.2 nm, and y above can be 0.7 nm to 2.0 nm.

(4) In any one of (1) to (3) above of the present invention, provided is the organic compound adsorbent wherein the metal organic framework can have a removal rate constant value of 0.03 or more calculated by Equation 2 below:

$${C}_{t} = {C}_{i} \times {e}^{- k t} \qquad [ Equation 2 ]$$

wherein in Equation 2 above:
Cₜ denotes the concentration of formaldehyde after t minutes;
Cᵢ denotes the concentration of formaldehyde at an initial stage;
k denotes the removal rate constant; and
t denotes the elapsed time (min).

(5) In any one of (1) to (4) above of the present invention, provided is the organic compound adsorbent wherein the metal organic framework can have a BET specific surface area of 800 m²/g or more.

(6) In any one of (1) to (5) above of the present invention, provided is the organic compound adsorbent wherein the metal ion can be an ion of at least one metal selected from the group consisting of sodium (Na), potassium (K), rubidium (Rb), calcium (Ca), strontium (Sr), barium (Ba), scandium (Sc), yttrium (Y), hafnium (Hf), niobium (Nb), chromium (Cr), silver (Ag), indium (In), germanium (Ge), tin (Sn), aluminum (Al), iron (Fe), molybdenum (Mo), tungsten (W), vanadium (V), zinc (Zn), zirconium (Zr), copper (Cu), magnesium (Mg), manganese (Mn), nickel (Ni), titanium (Ti), and lanthanide-based transition metals.

(7) In any one of (1) to (6) above of the present invention, provided is the organic compound adsorbent wherein the organic ligand can include at least two functional groups capable of bonding to the metal ion.

(8) In any one of (1) to (7) above of the present invention, provided is the organic compound adsorbent wherein the organic ligand can be at least one selected from the group consisting of imidazole, alkylimidazole, alkoxyimidazole, terephthalic acid, aminoterephthalic acid, trimesic acid, fumaric acid, and maleic acid.

(9) In any one of (1) to (8) above of the present invention, provided is the organic compound adsorbent wherein the carbonaceous support can include at least one selected from the group consisting of carbon nanotubes, graphene, graphite, amorphous carbon, carbon black, and activated carbon.

(10) In any one of (1) to (9) above of the present invention, provided is the organic compound adsorbent wherein the adsorbent can contain the metal organic framework in an amount of 3-95 parts by weight with respect to 100 parts by weight of the carbonaceous support.

(11) According to another aspect of the present invention, provided is a gas blower including the organic compound adsorbent according to any one of (1) to (10) above and having a gas flow rate.

### Advantageous Effects

According to the present invention, the metal organic framework has a BET specific surface area of 500 m²/g or more, and the relationship between the average diameter of the unit pore inlets and the average diameter inside the unit pores of the metal organic framework satisfies Equation 1. Thus, even in a dynamic gas flow having a flow rate of 1 cm/sec or more, the adsorption amount and the adsorption rate of volatile organic compounds can be improved, and therefore volatile organic compounds can be efficiently adsorbed in environments having a gas flow rate, such as an air purifier and an air conditioner.

### BRIEF DESCRIPTION OF THE DRAWINGS

FIG. 1 is a schematic diagram of a measuring device for evaluating the volatile organic compound removal performance of an organic compound adsorbent of the present invention.

FIG. 2 is a graph showing the amount of decrease in formaldehyde in the organic compound adsorbent of the present invention over time as measured through the measuring device.

FIG. 3 shows an image obtained by visualizing the crystal structure of the metal organic framework of Example 1 through a visualization program (Mercury).

### DETAILED DESCRIPTION

Terms or words used in this specification and claims should not be interpreted as being limited to a conventional or dictionary meaning, and should be interpreted as the meaning and concept that are consistent with the technical spirit, based on the principle that an inventor can appropriately define the concepts of terms in order to explain the invention in the best ways.

In the present invention, the diameter can be defined as a length of a longest straight line among straight lines connecting two different points in a circle, an oval, or a polygon forming a cross-section of a unit pore of a metal organic framework.

In addition, in the present invention, the average diameter can be defined as a diameter at a cumulative volume of 50% from the diameter distribution measured using any one or more of an X-ray diffraction, a gas adsorption, and a mercury porosimeter.

In addition, in the present invention, the average diameter inside the unit pores can mean the average depth inside the unit pores of the metal organic framework.

The metal organic framework is also referred to as the MOF, and is a crystalline organic-inorganic hybrid material in which metal ions or ion clusters are connected by an organic ligand acting as a linker to form a network of a primary, secondary, or tertiary structure.

Such a metal organic framework can be prepared by microwave heating synthesis for heating reactants using interaction between electromagnetic waves and a charged body, electrochemical synthesis using solvent heat after combining metal cationic materials such as Zn and Cu with linkers such as 1,3,5-H₃BTC and H₂BDC (OH)₂, or mechanochemical synthesis using a chemical conversion process after destroying intramolecular bonds.

Also, the metal organic framework can be used as a drug carrier in the field of biomedicine by regulating the functional groups on the surface of the metal organic framework or finely changing the pore size, and the metal organic framework contains metal ions or ion clusters, and thus can also be used as a heterogeneous catalyst in a catalytic reaction, an anaerobic olefin oxidation reaction, an olefin epoxidation reaction, a Friedel-Crafts benzylation reaction, and the like.

In particular, the metal organic framework has a porous structure in which an empty space exists in the skeleton. Due to the porous structure of the metal organic framework, the metal organic framework has a high gas storage capacity and can reversibly adsorb or desorb gas under mild conditions, and thus can be used in a field in which gases such as hydrogen, methane, and carbon dioxide are stored, and can selectively separate a specific gas from a gas mixture.

In addition, due to the porous structure of such a metal organic framework, the metal organic framework has adsorbability to various organic compounds, and particularly exhibits excellent adsorbability to volatile organic compounds (VOCs). The volatile organic compound is a generic term for a liquid or gaseous organic compound that is easily evaporated into the atmosphere, and is an air pollutant and a toxic chemical having carcinogenicity, which is also a precursor of photochemical oxide. There are naturally emitted compounds and artificially emitted compounds according to emission sources, and particularly, compounds such as formaldehyde and ammonia are problematic, and the organic compound adsorbent containing the metal organic framework exhibits more excellent adsorbability to volatile organic compounds than zeolite or activated carbon that has been widely used in the related art.

In general, the structure of the porous metal organic framework can have a form in which the average diameter inside the unit pores is larger than the average diameter of the unit pore inlets. Accordingly, volatile organic compound molecules that enter into the pores of the metal organic framework may not be re-desorbed and may be adsorbed inside the pores. In addition, in an environment of static gas flow, the average diameter inside the unit pores of the metal organic framework is increased so that the space, inside the pore, in which the volatile organic compounds can be adsorbed is increased, thereby improving the amount of the volatile organic compounds adsorbed.

However, even if the average diameter inside the unit pores of the metal organic framework is increased in an environment of dynamic gas flow such as an air purifier or an air conditioner, there is a limitation in that the volatile organic compounds may not enter into the pores due to rapid gas flow. In addition, when the average diameter of the unit pore inlets is increased in order for the volatile organic compounds to enter into the pores, there is a limitation in that the volatile organic compounds adsorbed inside the pores are re-desorbed. Accordingly, even if the metal organic framework is included in the organic compound adsorbent in order to adsorb the volatile organic compounds, there is a limitation in that the amount or rate of adsorbing the volatile organic compounds is reduced under a condition of dynamic gas flow, and thus there is a limitation in application to an air purifier or an air conditioner in a condition of dynamic gas flow.

As a result of a significant amount of research conducted for solving a limitation in that when the metal organic framework which has been conventionally used for adsorbing the volatile organic compounds is applied to an environment of gas flow such as an air purifier or an air conditioner, the adsorption amount and the adsorption rate of volatile organic compounds are reduced, the present inventors found that when the metal organic framework has a BET specific surface area of 500 m²/g or more and the relationship between the average diameter inside the unit pores of the metal organic framework and the average diameter inside the unit pores satisfies a specific condition, the adsorption amount and the adsorption rate of volatile organic compounds can be improved even in dynamic gas (e.g., air) flow having a flow rate of 1 cm/sec, and completed the present invention.

According to an aspect of the present invention provided is an organic compound adsorbent including: a metal organic framework which contains variable pores by a binding structure of metal ions and organic ligands, has a BET specific surface area of 500 m²/g or more, and satisfies Equation 1 below under gas flow having a flow rate of 1 cm/sec or more; and a carbonaceous support supported with the metal organic framework:

$$0.4 \leq x ( nm ) / y ( nm ) \leq 1. \qquad [ Equation 1 ]$$

wherein in Equation 1 above, x is the average diameter (nm) of the unit pore inlets of the metal organic framework as measured by at least one method selected from among an X-ray diffraction, a gas adsorption, and a mercury porosimeter, and y is the average diameter (nm) inside the unit pores of the metal organic framework as measured by at least one method selected from among an X-ray diffraction, a gas adsorption, and a mercury porosimeter.

The metal organic framework of the present invention contains variable pores by a binding structure of metal ions and organic ligands. The variable pores can mean that the diameter of the pore is not fixed but changes depending on a specific environment. Specifically, the organic ligands constituting the metal organic framework can have a characteristic in that the organic ligands are not fixed at room temperature but rotate about an axis that is bonded to metal ions, and thus the shape of the metal organic framework, the average diameter of the unit pore inlets of the metal organic framework, and the average diameter inside the unit pores can change according to the rotation of the organic ligands. In particular, when the metal organic framework is placed under a dynamic condition in which the flow of the surrounding gas has a specific flow rate, the average diameter of the unit pore inlets of the metal organic framework and the average diameter inside the unit pores can change.

In Equation 1 above, x/y, which is the average diameter value of the unit pore inlets of the metal organic framework/the average diameter value inside the unit pores, can be 0.4 or more, 0.45 or more, 0.5 or more, 0.53 or more, 0.55 or more, 0.58 or more, 1.0 or less, 0.95 or less, 0.9 or less, 0.85 or less, 0.8 or less, 0.75 or less, 0.7 or less, 0.65 or less, or 0.6 or less.

In Equation 1, when the average diameter (nm) of the unit pore inlets of the metal organic framework/the average diameter (nm) inside the unit pores of the metal organic framework deviates from the lower limit of the numerical range, the time required for the metal organic framework and the volatile organic compound to be in contact with each other is shorter than the time required for the metal organic framework to adsorb the volatile organic compound contained in the gas having the flow rate, and thus the effect of the metal organic framework adsorbing the volatile organic compound can be significantly reduced.

In addition, in Equation 1 above, when the average diameter (nm) of the unit pore inlets of the metal organic framework/the average diameter (nm) inside the unit pores of the metal organic framework deviates from the upper limit of the numerical range, the volatile organic compounds adsorbed in the pores of the metal organic framework can easily escape through the pore inlets of the metal organic framework, and thus there can occur a limitation in that the ratio of the volatile organic compounds to be re-desorbed from the metal organic framework is significantly increased. In addition, the metal organic framework of the present invention can have a BET specific surface area of 500 m²/g or more, 800 m²/g or more, 1,000 m²/g or more, or 1,500 m²/g or more.

In addition, in Equation 1 above, x can be 0.2 nm to 1.4 nm, and y can be 0.5 nm to 2.2 nm. More specifically, in Equation 1 above, x can be 0.2 nm or more, 0.25 nm or more, 0.3 nm or more, 0.3 nm or more, 0.35 nm or more, 0.4 nm or more, 1.4 nm or less, 1.3 nm or less, or 1.2 nm or less. In addition, in Equation 1 above, y can be 0.5 nm or more, 0.6 nm or more, 0.7 nm or more, 2.2 nm or less, 2.1 nm or less, or 2.0 nm or less.

The pore diameter of the metal organic framework satisfying the above-described range can reduce the rate at which the adsorbed volatile organic compounds are re-desorbed without deteriorating the performance of adsorbing the volatile organic compounds having a large molecular weight, thereby improving the adsorption rate as well as the amount of adsorbing the volatile organic compounds in the dynamic gas flow having a flow rate of 1 cm/sec or more.

According to an embodiment of the present invention, the organic compound adsorbent of the present invention can be an organic compound adsorbent in which the metal organic framework has a removal rate constant value of 0.03 or more calculated by Equation 2 below:

$${C}_{t} = {C}_{i} \times {e}^{- k t} \qquad [ Equation 2 ]$$

wherein in Equation 2 above:
Cₜ denotes the concentration (μmol/mol) of an organic compound of interest after t minutes, Cᵢ denotes the concentration (μmol/mol) of the organic compound of interest at an initial stage, k denotes the removal rate constant, and t denotes the elapsed time (min).

The organic compound of interest can be formaldehyde or ammonia, and specifically, formaldehyde. The removal rate constant k can be obtained from a linear regression analysis for t and InCₜ. The value of the removal rate constant k is an index from which the adsorption amount and the adsorption rate of the organic compound adsorbent can be confirmed, and when the value of the removal rate constant k satisfies the numerical range of 0.03 or more, the optimum adsorption amount and the adsorption rate for adsorbing volatile organic compounds in the dynamic gas flow can be achieved.

Meanwhile, the metal organic framework of the present invention is composed of a bonding structure of metal ions and organic ligands, and the metal ion can be an ion of at least one metal selected from the group consisting of sodium (Na), potassium (K), rubidium (Rb), calcium (Ca), strontium (Sr), barium (Ba), scandium (Sc), yttrium (Y), hafnium (Hf), niobium (Nb), chromium (Cr), silver (Ag), indium (In), germanium (Ge), tin (Sn), aluminum (Al), iron (Fe), molybdenum (Mo), tungsten (W), vanadium (V), zinc (Zn), zirconium (Zr), copper (Cu), magnesium (Mg), manganese (Mn), nickel (Ni), titanium (Ti), and lanthanide-based transition metals.

In addition, the organic ligand can include at least two functional groups capable of bonding to the metal ion, for example, can be a compound including a functional group containing nitrogen (N), oxygen (O), or sulfur (S), and specifically, can be one or more selected from the group consisting of imidazole, alkylimidazole, alkoxyimidazole, terephthalic acid, aminoterephthalic acid, trimesic acid, fumaric acid, and maleic acid.

In addition, the metal organic framework of the present invention can be a Materials Institute Lavoisier (MIL)-based metal organic framework, and preferably can be MIL-125 (Ti) containing a titanium-based (Ti) metal.

In addition, the metal organic framework of the present invention can have a moisture adsorption amount of 40 wt % or less as measured at a relative humidity of 100% or less. Specifically, the metal organic framework of the present invention can have a moisture adsorption amount of 40 wt % or less, 30 wt % or less, 20 wt % or less, or 10 wt % or less as measured at a relative humidity of 100% or less.

According to an embodiment of the present invention, provided is an organic compound adsorbent including a support supported with the metal organic framework. The support can be a carbonaceous support, and can include at least one selected from the group consisting of carbon nanotubes, graphene, graphite, amorphous carbon, carbon black, and activated carbon. In addition, it is preferable to use activated carbon having excellent toluene adsorption performance in consideration of the fact that the performance of adsorbing toluene among the volatile organic compounds of the metal organic framework is relatively inferior.

In addition, the metal organic framework can be contained in an amount of 3-95 parts by weight, 30-95 parts by weight, 50-90 parts by weight, or 50-80 parts by weight with respect to 100 parts by weight of the support. By satisfying the above-described range, there is an effect of reducing the phenomenon that the metal organic framework is detached by the external gas without deteriorating deodorizing properties.

The metal organic framework can be supported on the carbonaceous support in the form of powder, granules, or a coating, or can be supported between the carbonaceous supports. In addition, the organic compound adsorbent can be prepared by filling the metal organic framework between the carbonaceous supports in the form of a nonwoven fabric, the carbonaceous supports can be formed in the form of a mesh, and the carbonaceous supports can be adjusted in the form of a mesh having an appropriate size as necessary in order to prevent the metal organic framework from escaping to the outside of the organic compound adsorbent. When the carbonaceous support is formed in the form of a mesh, the carbonaceous support can have a mesh diameter of 160 μm or less, 150 μm or less, 140 μm or less, 130 μm or less, or 120 μm or less. The organic compound adsorbent can be a desiccant or a deodorizer.

In addition, according to another embodiment of the present disclosure, there is provided a gas blower including the organic compound adsorbent and having a gas flow rate. Specifically, the gas blower can be used without limitation in a product requiring an organic compound adsorbent among products having a gas flow rate, and for example, can be applied to various products such as an air purifier and an air conditioner.

Hereinafter, the present invention will be described in detail with reference to specific examples. However, the following examples are intended to illustrate the present invention, and the scope of the present specification is not limited thereto.

### EXAMPLES AND COMPARATIVE EXAMPLES

### Example 1

3.0 g of terephthalic acid was dissolved in 60 mL of dimethylformamide, and then 3 mL of anhydrous methanol and 3 mL of titanium isopropoxide were mixed therewith. This mixture was transferred to a 200-mL teflon vessel, then to a stainless steel autoclave, and then heated at 150° C. for 24 hours. After the mixture was cooled to room temperature, the formed white solid was obtained using a filter method, then washed once with 20 mL of DMF and three times with 40 mL of methanol, and then dried in a 100° C. vacuum oven to obtain a metal organic framework.

### Example 2

3.15 g of zirconium tetrachloride and 2.45 g of 2-aminoterephthalic acid were dissolved in 519 mL of dimethylformamide and then heated in an oven at 120° C. for 6 hours without stirring. After the mixture was cooled to room temperature, the formed pale yellow solid was obtained using a filter method, then washed once with 100 mL of DMF and three times with 100 mL of methanol, and then dried in a 120° C. vacuum oven to obtain a metal organic framework.

### Example 3

8.1 g of fumaric acid and 23 g of dichloro(oxo)zirconium octahydrate were dissolved in a mixed solvent of 3,500 mL of dimethylformamide and 530 mL of formic acid, and then the resultant mixture was heated in an oven at 120° C. for 24 hours without stirring. After the mixture was cooled to room temperature, the formed pale white solid was obtained using a filter method, then washed once with 200 mL of DMF and three times with 1,000 mL of methanol, and then dried in a 150° C. vacuum oven to obtain a metal organic framework.

### Comparative Example 1

3.5 g of zirconium tetrachloride and 2.5 g of terephthalic acid were dissolved in 155 mL of dimethylformamide, and then 1.5 mL of 36% aqueous hydrochloric acid solution was mixed therewith. The resulting mixture was heated in an oven at 120° C. for 24 hours without stirring. After the mixture was cooled to room temperature, the formed white solid was obtained using a filter method, then washed once with 100 mL of DMF and three times with 100 mL of methanol, and then dried in a 120° C. vacuum oven to obtain a metal organic framework.

### Comparative Example 2

Solution 1 was prepared by dissolving 5.94 g of zinc nitrate hexahydrate in 30 mL of distilled water, and Solution 2 was prepared by mixing 3.28 g of 2-methylimidazole, 50 mL of triethylamine, and 37.6 g of a saturated aqueous ammonia solution. Solution 1 and Solution 2 were mixed and stirred at room temperature for 10 minutes, and then the formed white solid was obtained by using centrifugation. The white solid was washed once with 100 mL of DMF and three times with 100 mL of methanol, and then dried in a 120° C. vacuum oven to obtain a metal organic framework.

### Comparative Example 3

4.75 g of magnesium nitrate hexahydrate and 11.6 g of 2,6-dihydroxyterephthalic acid were dissolved in 440 mL of dimethylformamide. This solution was mixed with 30 mL of ethanol and 30 mL of aqueous solution and then the resultant mixture was heated in a 125° C. oven for 15 hours. After the mixture was cooled to room temperature, the formed dark yellow solid was obtained using a filter, then washed once with 200 mL of DMF and three times with 100 mL of methanol, and then dried in a 120° C. vacuum oven to obtain a metal organic framework.

### EXPERIMENTAL EXAMPLES

### Experimental Example 1

For the metal organic framework of the Examples and Comparative Examples, the average diameter of the unit pore inlets, the average diameter inside the unit pores, the BET specific surface area, and the VOC removal performance were measured by the following method, and the measurement results are shown in Table 1 below. In addition, a clean air delivery rate (CADR) and a removal rate constant were calculated to compare the removal performance of the Examples and Comparative Examples after measuring the VOC removal performance, and the results are shown in Table 1 below.

1) Measurement of the average diameter of the unit pore inlets and the inside of the pores: The synthesis of each of Examples and Comparative Examples was confirmed by obtaining the crystal structure of the metal organic framework by visualizing the crystal information file (CIF) of the metal organic framework as measured from the X-ray diffraction analysis (XRD equipment and conditions: Bruker SMART Apex Diffractometer, Mo Kα radiation, 0.71073A wavelength, 30 sec/frame, Angle 0-180 deg) through a visualization program (Mercury). Then, by using the single crystal structure included in the Cambridge Structural Database (CSD), the average diameter of the unit pore inlets was measured by measuring the center distance between two atoms that are farthest among the atoms constituting the inlet of the unit pore of the metal organic framework. In addition, a method for measuring the average diameter inside the unit pores was performed in the same manner as the method for measuring the average diameter of the unit pore inlets, except that the center distance between two atoms that are farthest among the atoms constituting the inside of the unit pores of the organic metal structure was measured.

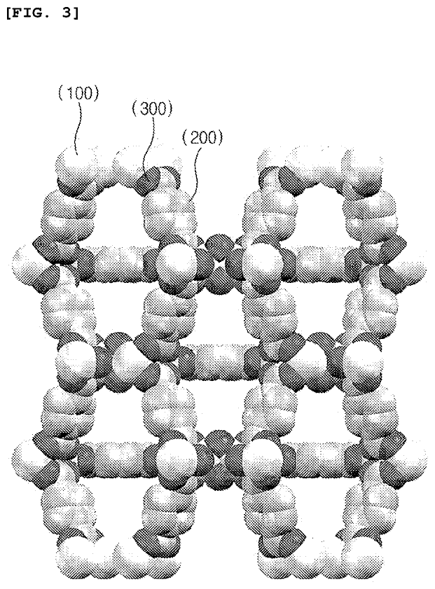

FIG. 3 shows an image obtained by visualizing the crystal structure of the metal organic framework of Example 1 through a visualization program (Mercury). Referring to FIG. 3, the image shows an average position of atoms constituting the crystal structure of the metal organic framework by repeatedly photographing the crystal structure of the metal organic framework through the visualization program. 100 represents a titanium atom, 200 represents a carbon atom, and 300 represents an oxygen atom.

2) Measurement of BET specific surface area: The surface area was measured by a nitrogen low-temperature adsorption method using BELSORP-max II manufactured by BEL Japan. Each metal organic framework was heated in vacuum at 120° C. for 12 hours to remove moisture and residual solvent contained in the metal organic framework. In a state in which the vacuum-dried metal organic framework is cooled with liquid nitrogen, an adsorption curve of nitrogen gas is measured, and then a surface area is measured with the BET method using the adsorption curve.

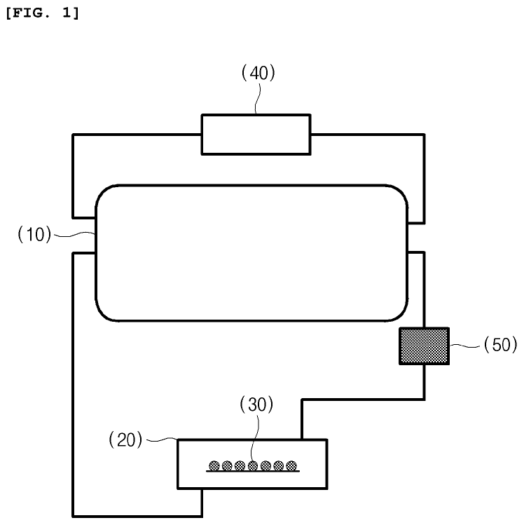

3) Measurement of VOC removal performance: The VOC removal performance of the metal organic framework was measured using the measuring device shown in FIG. 1. FIG. 1 is a schematic diagram of a measuring device for evaluating the volatile organic compound removal performance of an organic compound adsorbent of the present invention.

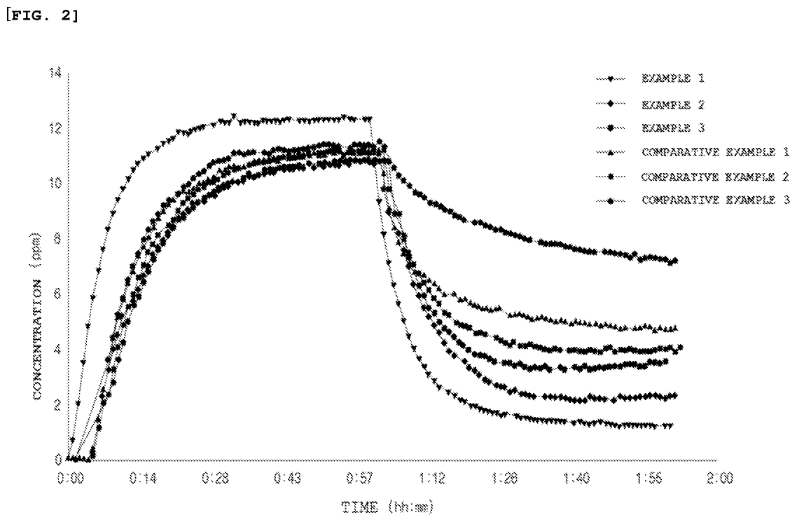

After injecting a mixed gas of formaldehyde and nitrogen having a concentration of 30-50 ppm stored in an external bombe into a mixing tank 10, nitrogen was added to dilute the concentration of formaldehyde in the mixing tank to 10 ppm. After the concentration of 10 ppm was stabilized, formaldehyde was injected into the holder 20 containing the metal organic framework 30 in a powder state. The formaldehyde gas injected into the holder was injected in an amount of 3 L per minute using a pump 50, and the volume of the holder 20 was about 39 cm³, and the flow rate through the metal organic framework was measured as 76.4 cm/min. While the injected formaldehyde passes through the sample and is removed through adsorption, the concentration of formaldehyde decreases, and the change in the concentration of formaldehyde by time was recorded by measuring the concentration of formaldehyde using the measuring device 40. Accordingly, a graph showing a decrease in formaldehyde by time of each metal organic framework is shown in FIG. 2.

4) Calculation of removal rate constant k and CADR: The removal rate constant k can be calculated by Equation 2 below, and CADR can be calculated by Equation 3 below. The CADR is an index used to evaluate the performance of the air purifier and indicates an amount of air that can be purified per unit area and unit time:

$${C}_{t} = {C}_{i} \times {e}^{- k t} \qquad [ Equation 2 ]$$

wherein in Equation 2 above:

Cₜ denotes the concentration (μmol/mol) of an organic compound of interest after t minutes, Cᵢ denotes the concentration (μmol/mol) of the organic compound of interest at an initial stage, k denotes the removal rate constant, and t denotes the elapsed time (min).

$$CADR = - ( V / t ) \times ( ln ( {C}_{t 2} / {C}_{i 2} ) - ln ( {C}_{t 1} / {C}_{i 1} ) ) \qquad [ Equation 3 ]$$

In Equation 3 above:

CADR denotes the purification capability (m³/min), V denotes the test chamber volume (m³), T denotes the measurement time (min) during the reduced operation, Cᵢ₁ denotes the particle concentration (numbers/cm³) at the measurement starting point t=0 when naturally reduced, Cᵢ₂ denotes the particle concentration (numbers/cm³) at the measurement starting point t=0 during the reduced operation, Cₜ₁ denotes the particle concentration (numbers/cm³) at the measurement time, t minute, when naturally reduced, and Cₜ₂ denotes the particle concentration (numbers/cm³) at the measurement time, t minute, during the reduced operation.

TABLE 1

| | Example | Example | Example | Comparative | Comparative | Comparative |
|---|---|---|---|---|---|---|
| Division | 1 | 2 | 3 | Example 1 | Example 2 | Example 3 |
| k (removal | 0.069 | 0.052 | 0.034 | 0.021 | 0.029 | 0.01 |
| rate | | | | | | |
| constant) | | | | | | |
| CADR | 0.5 | 0.4 | 0.3 | 0.2 | 0.2 | 0.1 |
| BET(m²/g) | 1,530 | 800 | 990 | 1,100 | 1,340 | 150 |
| Pore inlet | 1.137 | 0.394 | 0.57 | 0.5345 | 0.58 | 1.6605 |
| (Ap, nm) | | | | | | |
| Pore inside | 1.9613 | 0.744 | 1.0285 | 1.4685 | 1.69 | 1.6605 |
| (Ca, nm) | | | | | | |
| Ap/Ca | 0.58 | 0.53 | 0.55 | 0.36 | 0.34 | 1 |

FIG. 2 is a graph showing the amount of decrease in formaldehyde in the organic compound adsorbent of the present invention over time as measured through the measuring device. Referring to Table 1 above and FIG. 2, it can be seen that Examples 1 to 3 satisfy the average diameter of the inlet and the inside of the unit pores of the metal organic framework and Equation 1 above, and further, the BET specific surface area is 500 m²/g or more, and thus the removal rate constant k value is exhibited high as 0.03 or more. On the other hand, it can be seen that Comparative Examples 1 and 2 do not satisfy the average diameter of the inlet and the inside of the pores and Equation 1 even though the BET specific surface area is 1,000 m²/g or more, and thus the removal rate constant value is less than 0.03, which is relatively lower than Examples. In addition, it can be seen that Comparative Example 3 satisfies Equation 1, but the BET specific surface area value corresponds to less than 500 m²/g, and thus the removal rate constant value is remarkably low. Accordingly, it can be confirmed that as in the present invention, when the average diameter values of the inlet and the inside of the pores of the metal organic framework and the numerical range of Equation 1 are satisfied, and at the same time, the BET specific surface area value is 500 m²/g or more, the metal organic framework having the most efficient adsorption amount and adsorption rate can be obtained, and an organic compound adsorbent containing the metal organic framework can be obtained.
10: Mixing tank
20: Holder
30: Organic compound adsorbent
40: VOC concentration measuring device
50: Pump
100: Titanium atom
200: Carbon atom
300: Oxygen atom

1. An organic compound adsorbent, comprising:
a metal organic framework which contains variable pores by a binding structure of metal ions and an organic ligand, has a BET specific surface area of 500 m²/g or more, and satisfies Equation 1 below under gas flow having a flow rate of 1 cm/sec or more; and
a carbonaceous support supported with the metal organic framework:
$$0.4 \leq x ( nm ) / y ( nm ) \leq 1. \qquad [ Equation 1 ]$$
wherein, in Equation 1 above:
x is an average diameter (nm) of a unit pore inlet of the metal organic framework as measured by at least one method selected from among an X-ray diffraction, a gas adsorption, and a mercury porosimeter; and
y is an average diameter (nm) inside a unit pore of the metal organic framework as measured by at least one method selected from among an X-ray diffraction, a gas adsorption, and a mercury porosimeter.

2. The organic compound adsorbent of claim 1, wherein x is between 0.2 nm or more and 1.4 nm or less, and y is between 0.5 nm or more and 2.2 nm or less.

3. The organic compound adsorbent of claim 1, wherein x is between 0.35 nm or more and 1.2 nm or less, and y is between 0.7 nm or more and 2.0 nm or less.

4. The organic compound adsorbent of claim 1, wherein the metal organic framework has a removal rate constant value of 0.03 or more calculated by Equation 2 below:
$${C}_{t} = {C}_{i} \times {e}^{- k t} \qquad [ Equation 2 ]$$
wherein, in Equation 2 above:
Cₜ is a concentration (μmol/mol) of a formaldehyde after t minutes;
Cᵢ is a concentration (μmol/mol) of a formaldehyde at an initial stage;
k is a removal rate constant; and
t is an elapsed time (min).

5. The organic compound adsorbent of claim 1, wherein the BET specific surface area of the metal organic framework is 800 m²/g or more.

6. The organic compound adsorbent of claim 1, wherein the metal ion is an ion of at least one metal selected from a group consisting of sodium (Na), potassium (K), rubidium (Rb), calcium (Ca), strontium (Sr), barium (Ba), scandium (Sc), yttrium (Y), hafnium (Hf), niobium (Nb), chromium (Cr), silver (Ag), indium (In), germanium (Ge), tin (Sn), aluminum (Al), iron (Fe), molybdenum (Mo), tungsten (W), vanadium (V), zinc (Zn), zirconium (Zr), copper (Cu), magnesium (Mg), manganese (Mn), nickel (Ni), titanium (Ti), and lanthanide-based transition metals.

7. The organic compound adsorbent of claim 1, wherein the organic ligand contains at least two functional groups capable of bonding to the metal ion.

8. The organic compound adsorbent of claim 1, wherein the organic ligand is at least one selected from a group consisting of imidazole, alkylimidazole, alkoxyimidazole, terephthalic acid, aminoterephthalic acid, trimesic acid, fumaric acid, and maleic acid.

9. The organic compound adsorbent of claim 1, wherein the carbonaceous support comprises at least one selected from a group consisting of carbon nanotubes, graphene, graphite, amorphous carbon, carbon black, and activated carbon.

10. The organic compound adsorbent of claim 9, wherein the adsorbent contains the metal organic framework in an amount of 3-95 parts by weight with respect to 100 parts by weight of the carbonaceous support.

11. A gas blower including the organic compound adsorbent according to claim 1 and having a gas flow rate.
